(19) United States
(12) Patent Application Publication
(10) Pub. No.: US 2010/0064124 A1
(43) Pub. Date: Mar. 11, 2010

(54) DIGITAL POWER CONTROLLER

(76) Inventors: Karl Rinne, County Cork (IE); Eamon O'Malley, County Mayo (IE)

Correspondence Address: HICKMAN PALERMO TRUONG & BECKER, LLP, 2055 GATEWAY PLACE, SUITE 550, SAN JOSE, CA, 95110, US

(21) Appl. No.: 12/515,253

(22) PCT Filed: Nov. 15, 2007
(86) PCT No.: PCT/IE07/00112

§ 371 Date: May 15, 2009

(30) Foreign Application Priority Data
Nov. 16, 2006 (IE) 2006/0831

(51) Int. Cl. G06F 9/06; H02M 1/08

(52) U.S. Cl. 713/1; 710/8; 714/24; 713/300; 713/320

(57) ABSTRACT

A digital power controller (DPC, 1) controls an SMPC power stage (2). The DPC (1) interfaces with the SMPC power stage (2), and it has a system-on-a-chip (SoC) architecture including a digital signal processor (DSP, 5) for real-time control of SMPC outputs (such as output voltage) and a RISC processor (CPU, 6). An ADC (7) receives sense signals and routes them to the DSP (5), and a DPWM circuit (8) drives the SMPC. Communication with the CPU (6) is via a bus (10). The CPU (6) features include fault management and data transfers to the DSP co-processors and other peripheral blocks.

### FIELD OF THE INVENTION

The invention relates to digital power controllers for controlling power converters such as switch mode power converters (SMPCs).

### PRIOR ART DISCUSSION

Switch-mode power converters (SMPCs) are used to power microelectronic devices (e.g. processors) in electronic circuits and systems. SMPCs are becoming increasingly popular because of their inherently high power conversion efficiency. Particularly for portable electronic devices (such as laptops or digital cameras) SMPCs extend the lifetime of the batteries and the availability of the device. Commonly, SMPCs determine the ergonomics (volume and weight) and the usefulness (availability, battery lifetime) of electronic devices.

To date, the control circuitry for power converters has been predominantly analogue. It typically consists of a PWM controller and a number of discrete components including resistors and capacitors setting the desired parameters, such as switching frequency, compensator frequency behaviour, start-up behaviour, and protection features. The discrete components “program” the operational behaviour of the PWM controller. Increasingly, due to complexity, a number of housekeeping and supervision functions (such as startup) are implemented using microcontrollers, augmenting the functionality of the PWM controller. Commonly, a set of 20-100 components is required to implement the complete control circuitry of analogue SMPCs.

A number of technical challenges need to be addressed in order to make digital power converter control a practical and cost-effective reality. The main challenges are:
Components need to be streamlined and optimised specifically for the application. General-purpose building blocks, such as off-the-shelf DSPs or FPGAs fail to meet the cost expectations of the SMPC industry.
Some components, including the ADCs and DPWMs, have specific sets of requirements (e.g. latency, quantisation function, resolution).
Components in the real-time control path (ADCs, DSP and DPWM) need to provide their respective outputs with very low latency in order to be compatible with cycle-by-cycle control of power converters switching at elevated frequencies.
Components are exposed to adverse environmental conditions. They need to operate ruggedly in the presence of wide temperature variations, and strong electro-magnetic interferences.
Components need to be fault-tolerant, and recover from abnormal operating conditions (caused e.g. by ESD pulses or mains surges) in a benign and controlled fashion.

FIGS. 1 to 4 show four known DPC architectures.

In the architecture shown in FIG. 1, the signal processor is implemented directly in fixed hardware (and was therefore called a “hardwired controller”). This architecture is useful for the implementation of simple (and typically linear) control laws. As the hardware is fixed, the control law is fixed (i.e. static), and cannot be changed after the DPC is manufactured. This limits the application of the DPC to SMPC applications where only small variations of the power system are expected. Complex control laws, such as adaptive or self-tuning controllers cannot be implemented efficiently with this approach. For even greater simplicity, even the coefficients of the control laws (difference equations involving discrete additions and multiplications) were made constant, which in turn fixes the frequency behaviour of the control law. This led to simpler hardware again, but is even more restrictive in terms of application. Other variants include implementations where the control law was implemented using data lookup tables, replacing multipliers by read-only memories. Typical research publications and experimental/commercial implementations of this architecture include: [1], [2], [3], [4], [7], [8].

As an alterative to hardwired controllers, central processing units (CPUs) have been used to implement programmable signal processors, as shown in FIG. 2. With this architecture, both the control law and its frequency behaviour are programmable. However, typical CPUs do not support the efficient implementation of digital control laws as they lack MAC (Multiply-And-Accumulate) capabilities. The speed of processing poses an unacceptable limit in terms of closed-loop performance. The situation is further compounded if the CPU is also required to handle other system tasks (such as communication), leaving even less CPU resources available for the control law. While—in theory—complex control laws could be implemented, poor processing performance would not support high switching frequencies. This architecture is only suitable for power systems with extremely small switching frequencies.

The restriction in terms of CPU processing speed has been addressed in the DPC architecture shown in FIG. 3. Here, a hardware accelerator provides fast MAC operations, and is used to implement autonomous execution of standard control laws. The presence of the hardware accelerator frees up the CPU so that the CPU can assign all its processing capabilities to housekeeping and fault management tasks, as well as communication. This architecture suffers from the same restrictions as FIG. 1 in terms of inflexibility of control law and frequency response behaviour. Commercial implementations of this architecture include: [5], [13].

As recent research into advanced control laws (such as adaptive and self-tuning control laws) intensified and demonstrated their benefits, a new architecture evolved as shown in FIG. 4. A standard off-the-shelf DSP core, with powerful and flexible signal processing features, was augmented by SMPC-specific building blocks ADC and DPWM. The standard off-the-shelf DSP core with its powerful generic instruction set and large-scale internal memory is able to handle even the most complex signal processing demands. However, as the DSP also need to assign some processing resources to housekeeping and communication, very high DSP clock frequencies are required. This architecture has further drawbacks. The DSP is generic, and its internal organisation and instruction set as well as its memory capabilities are over-designed for the specific power system application. This in turn leads to large silicon area (when integrated), high power dissipation due to high clock frequencies, and ultimately high cost. Implementations of this architecture include: [9], [10], [11], [12], [14], and [15].

The invention is directed towards providing an improved digital power controller to satisfy at least some of the above challenges.

### References

[1] Power-One ZY7010 DC-DC Intelligent POL Datasheet, March 2005, available from, http://www.powerone.com/resources/products/datasheet/zy7010.pdf
[2] Peterchev, A. V., J. Xiao and S. R. Sanders, 2003. “Architecture and IC Implementation of a Digital VRM Controller” IEEE Transactions on Power Electronics, Vol. 18, No. 1, pp. 356-364, January 2003
[3] Patella, B. J., A. Prodic, A. Zirger, and D. Maksimovic, 2002. “High-Frequency Digital Controller IC for DC/DC converters.” IEEE Transactions on Power Electronics, Vol. 18, No. 1, pp. 438-446, January 2003
[4] Prodic, A., D. Maksimovic and R. W. Erickson, 2002. “Design of a Digital PID Regulator Based on Look-Up Tables for Control of High-Frequency DC-DC Converters.” In: IEEE Workshop on Computers in Power Electronics, Jun. 3-4, 2002
[5]0 Si8250/1/2: Digital Power Controller from Silicon Laboratories: Datasheet available from www.silabs.com
[6] UCD9501: 32-Bit Digital Signal Controller for Power Management. Datasheet available from www.ti.com
[7] PX7510: Power Management and Conversion IC. Visit www.primadon.com
[8] ZL2005: Digital-DCTM Integrated Power Management and Conversion IC: Visit www.zilkerlabs.com
[9] Motorola DSP56K Family Data Sheet, “24-bit Digital Signal Processor Family Manual”, Mar. 10, 1995. Available from www.motorola.com
[10] Texas Instruments TMS320F/24× DSP Controllers Reference Guide, “CPU and Instruction Set”, June 1999. Available from www.ti.com
[11] Texas Instruments TMS320F243/F241/C242 DSP Controllers Reference Guide, “System and Peripherals”, January 2000. Available from www.ti.com
[12] Texas Instruments TMS320C54×/LC54×/VC54× Fixed-Point Digital Signal Processors Datasheet, February 1996. Available from www.ti.com
[13] Texas Instruments UCD9240 Digital Point of Load System Controller Datasheet, 2007. Available from www.ti.com
[14] Analog Devices ADSP-2104/ADSP-2109 Low Cost DSP Microcomputers Datasheet, February 1996. Available from www.analog.com
[15] Motorola DSP56000/SPS/DSP56001 Digital Signal Processors, “Implementation of PID Controllers”. Available from www.motorola.com.
[16] Analog Devices ADSP-21990: Application Note AN21990-13, “Implementation of PI Controllers”. Available from www.analog.com

### SUMMARY OF THE INVENTION

According to the invention, there is provided a digital power controller for controlling a power converter, the controller comprising a CPU, a bus, and peripheral devices communicating with the CPU via the bus, said peripheral devices including a co-processor executing control algorithms, an ADC receiving power converter sense signals, and a modulator providing output drive signals to the power converter.

In one embodiment, the CPU has a RISC architecture.

In one embodiment, the digital power controller has a system-on-chip architecture.

In one embodiment, the peripheral devices operate as autonomous slaves.

In another embodiment, the modulator is a digital pulse width modulator (DPWM).

In one embodiment, the CPU performs housekeeping and communication operations, and the peripheral devices primarily perform real time power converter control.

In one embodiment, the CPU comprises blocks for self-test, peripheral device initialisation, parameter retrieval, and runtime routines.

In one embodiment, the CPU comprises means for detecting abnormal conditions and for generating real time responses.

In a further embodiment, the CPU comprises means for shutting down the power converter.

In one embodiment, the CPU comprises means for causing temporary shut-down of the power converter followed by automatic re-start attempts.

In one embodiment, said abnormal conditions include over-temperature, input under-voltage lockout, output over-voltage, and output over-current.

In one embodiment, the CPU comprises means for performing configuration of the peripheral devices.

In one embodiment, the CPU comprises means for performing initialisation of setpoint values.

In a further embodiment, the co-processor is a DSP.

In one embodiment, the CPU comprises means for transferring a co-processor algorithm from non-volatile instruction memory to the co-processor.

In one embodiment, the CPU comprises means for, at start-up, transferring co-processor control law and coefficients determining frequency behaviour of the control law.

In one embodiment, the co-processor comprises means for modifying control laws, for adaptive control laws.

In one embodiment, the co-processor comprises means for modifying control laws coefficients, for adaptive control laws.

In one embodiment, the CPU and the co-processor comprise means for managing control system set-points, setting target values for power converter variables in closed-loop real-time control.

In one embodiment, the CPU comprises means for, during start-up, transferring an initial set-point to the co-processor, and the co-processor comprises means for changing the set-point from time to time in response to CPU instructions, and the co-processor comprises means for using the new set-point as new target values in closed-loop control.

In another embodiment, the CPU comprises means for requesting the DSP to resume closed loop control, in response to a request from a host that power conversion should stop or start or as a result of detection of fault detection, or recovery from fault detection.

In one embodiment, the co-processor comprises means for transmitting status flags to the CPU, allowing detection of DSP faults, and adequate response to these faults.

In another aspect, the invention provides a power converter system comprising a power converter and any digital power controller as defined above.

In one embodiment, the power converter is a switch mode power converter

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 5 is a block diagram showing a digital power controller (“DPC”) of the invention controlling an SMPC power stage;

FIG. 6 is block diagram showing architecture of the DPC at a high level;

FIG. 7 is a more detailed block diagram, showing a CPU of the DPC;

FIG. 8 is a more detailed block diagram, showing a DSP of the DPC; and

FIG. 9 is a flow diagram showing breakdown of operations of the DSP and the CPU.

### DESCRIPTION OF THE EMBODIMENTS

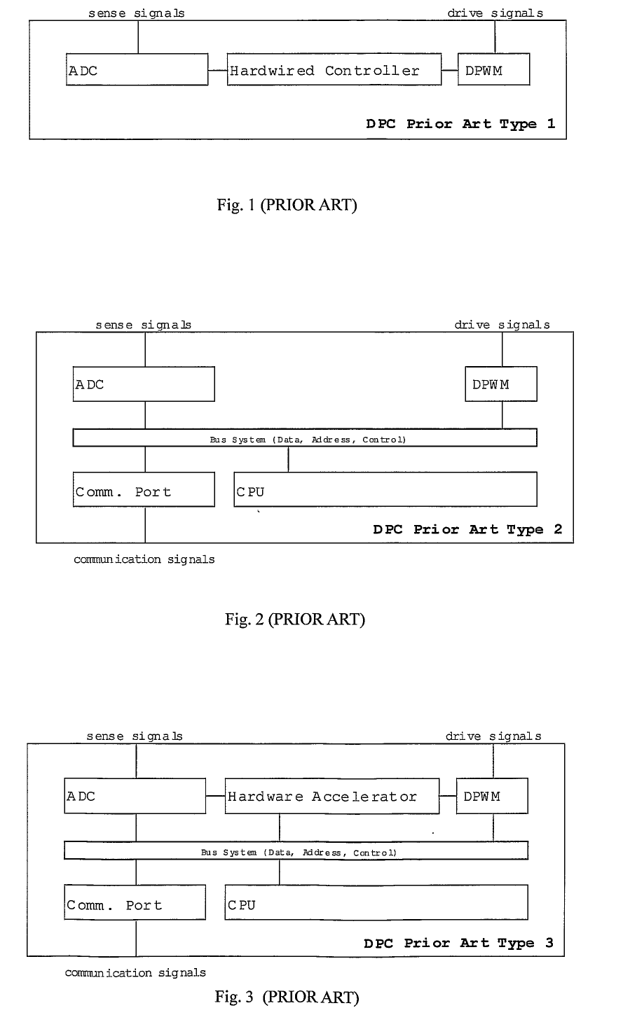

Referring to FIG. 5 a digital power controller (“DPC”) 1 of the invention controls an SMPC power stage 2. The DPC 1 interfaces with the SMPC power stage 2 in a manner akin to that of the prior art, the invention lying in the internal architecture of the DPC 1.

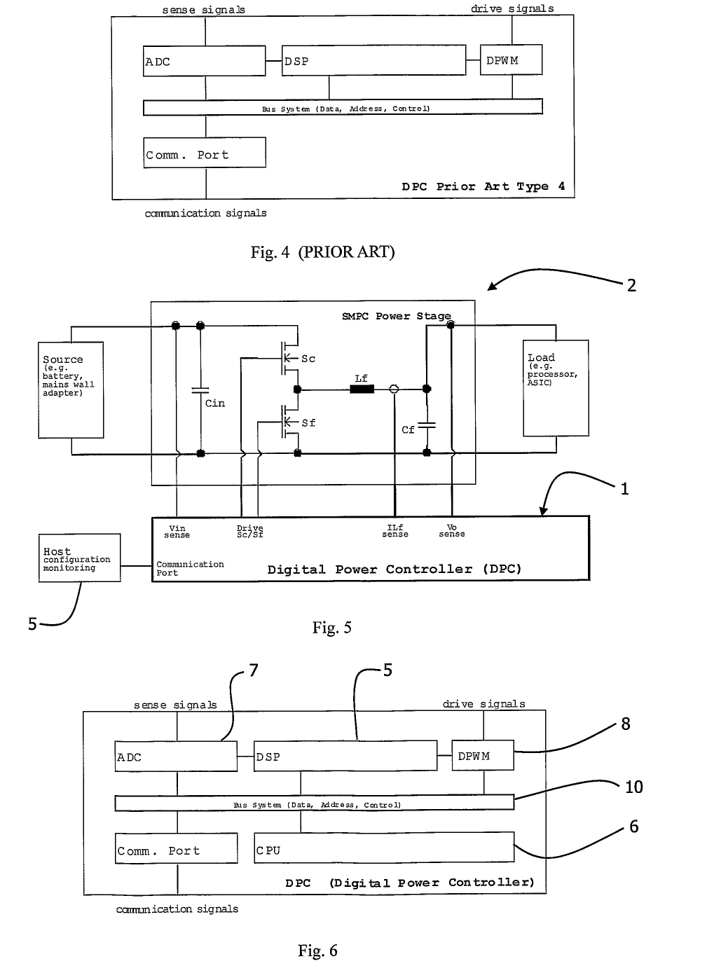

Referring to FIG. 6, the DPC 1 has a system-on-a-chip (SoC) architecture including a digital signal processor (DSP) 5 for real-time control of SMPC outputs (such as output voltage) and a RISC processor CPU 6, as shown in FIG. 6. An ADC 7 receives sense signals and routes them to the DSP 5, and a DPWM circuit 8 drives the SMPC. Communication with the CPU 6 is via a bus 10. The RISC 6 processor features include fault management and data transfers to DSP co-processors (and other peripheral blocks).

The DPC 1 is implemented using CMOS ASIC technology, which can be manufactured cost-effectively. It is capable of controlling a wide range of SMPC topologies, including non-isolated multi-phase converters, as well as a range of isolated converter topologies (such as half-bridge and active reset converters). The DPC architecture is based on an SoC interconnect bus of the industry-standard AMBA type. Because of its CPU-based architecture, the DPC 1 is capable of supporting a wide range of communication interfaces and protocols (such as PMBUS).

Processor and peripheral blocks are interconnected through the SoC bus 10. The processor 6 is the single master of this SoC bus 10, while the peripheral blocks act as autonomous slaves. The processor can fully control and monitor the slaves through the SoC bus 10. Slaves include the DSP 5, the digital pulse width modulator (DPWM) 8, as well as the analogue-to-digital converter (ADC) 7. Once set-up and initialised, the slaves operate independently of the processor. The CPU 6 is primarily used for housekeeping control and communication, however it also performs some real time operations such as real time fault management.

The DPC 1 implements by way of the CPU 6, initial configuration after reset, housekeeping in normal operation, fault management and communication (with optional hosts).

Each of the two DSP 5 and the CPU 6 is fully and independently programmable through software. Independent tasks can be clearly assigned to each of the processing units.

The CPU 6 handles the following tasks:
SMPC Fault Management. Detection of, and coordinated response to, SMPC abnormal situations and protection of SMPC, load and supply. These protection mechanisms include over-temperature protection (OTP), input under-voltage lockout (UVLO), output voltage over-voltage protection (OVP), output over-current protection (OCP)
Communication. Communication with the host 20 (PC) for the purpose of receiving SMPC configuration instructions from the host, and delivering status information to the host.
Other system tasks, including: built-in self-test (BIST) after start-up, configuration of the DSP, including the transfer of the algorithm as well as coefficients to the DSP, configuration of all other building blocks of the DPC, including ADC 7, DPWM 8 and communication ports, initialisation of setpoint values, coordination of start/stop of DSP, and management of memories (such as volatile and non-volatile memories).

The DSP 5 handles the following tasks:
Real-time control of the SMPC,
Other DSP tasks, including: built-in self-test (BIST) after start-up, reception of algorithm and coefficients after start-up, and reception of new setpoint values (which may change from time to time) from CPU.

It is important to note that, once initialised, the DSP 5 autonomously carries out the task of real-time control of the SMPC. Neither the CPU 6, nor the optional host, need to assign resources to real-time control. Real-time control, in this context, is defined as the task of regulating the desired SMPC variable (most commonly the output voltage) to a desired value, with stringent timing constraints, by means of processing the sampled and quantised SMPC variables (such as output voltage, input voltage, output current) and determining corrective action by providing suitable actuator (or drive) signals.

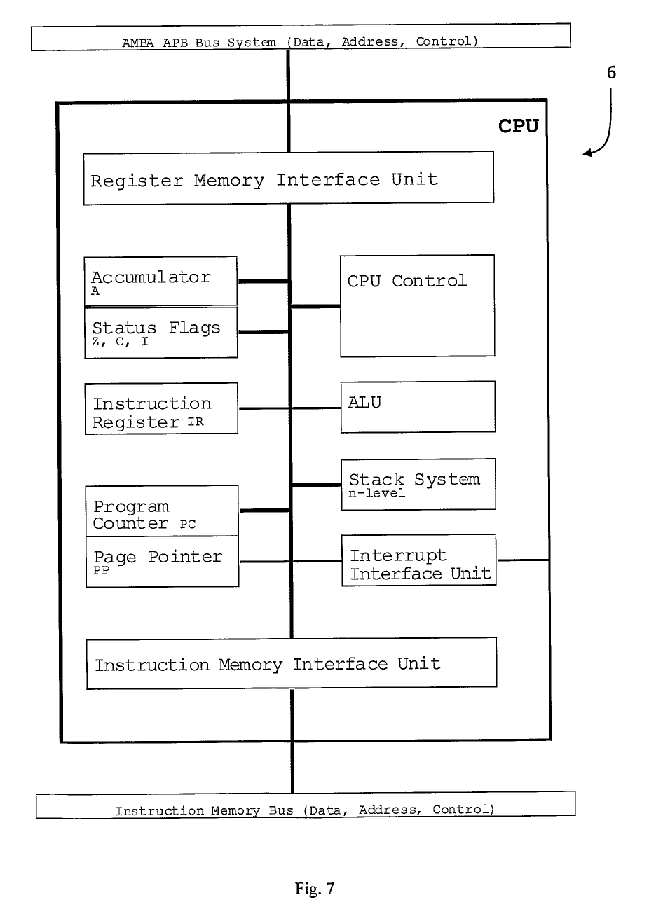

The structure of the CPU is shown in FIG. 7. The CPU 6 has two main bus interfaces:
Interface to the DPC components namely (ADC 7, DPWM 8, DSP 5). The CPU 6 uses an open standard interface, in this embodiment an AMBA. The CPU 6 is the single master driving this interface.
Interface to the instruction memory

The CPU 6 has a set of working registers holding temporary data (including the accumulator A), an arithmetic logic unit (ALU) for performing standard sets of arithmetic and logic operations, and a set of status registers (carry flag C, zero flag Z). A program counter PC points to the next instruction to be fetched from instruction memory. An optional page pointer PP holds the value of the current instruction page in memory (if the instruction memory is arranged in pages). An instruction register IR holds the current instruction value. For temporary storage of return addresses (and possibly data) a stack system is used, capable of storing a defined number n of return addresses or data words (n-level stack). The CPU 6 is also capable of handing and managing interrupt requests. All activity of the CPU 6 is organised by a sequential state machine, sometimes referred to as the CPU control state machine.

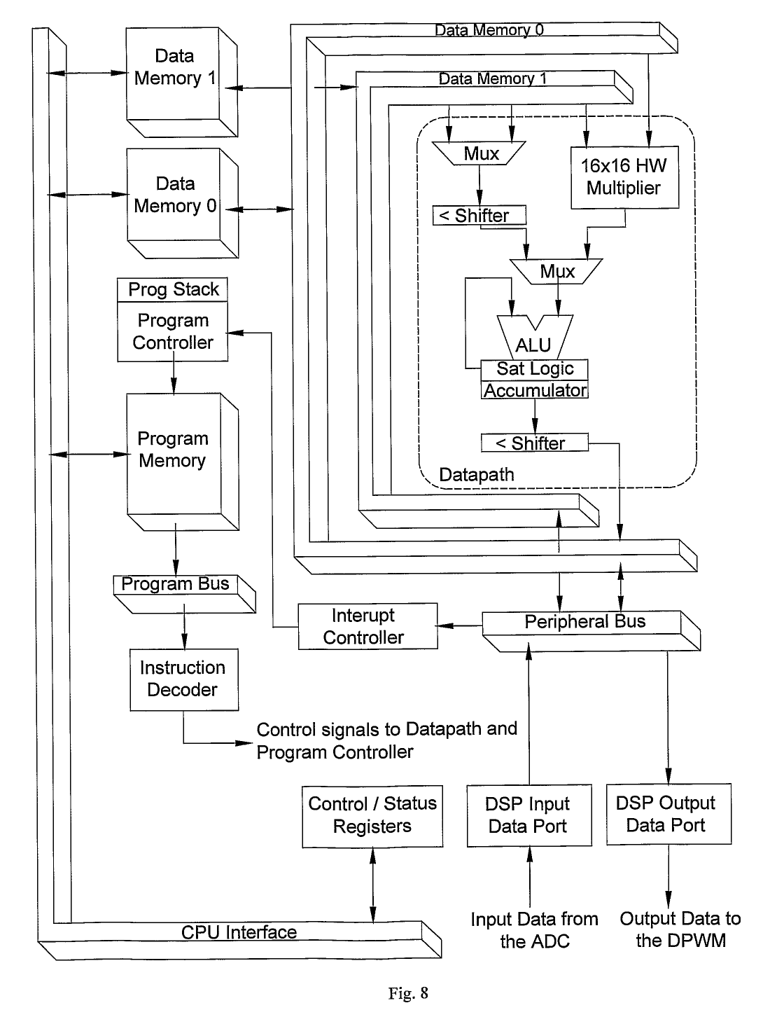

The DSP 5 is optimised for the purpose of real-time control of SMPCs and is shown in FIG. 8. The DSP 5 has its own local volatile instruction memory (program memory) holding the software ready for execution. Upon startup, the CPU 6 transmits the DSP software to its local program memory. Further, the DSP has its own set of data memory for storage of data. The data memories hold control law coefficients, as well as sampled and quantised SMPC signals of the most recent, and possibly also previous n switching cycles. Using these discrete samples, in conjunction with the coefficients, the control law can be executed (independently of the CPU 6) utilising the DSP's high-speed MAC capabilities residing in its ALU, and result signal(s) in the form of duty cycle commands can be forwarded to the actuator (DPWM) so that the real-time control goal is achieved. The DSP 5 typically provides its own high-speed interfaces to the ADC 7 and the DPWM 8.

The CPU 6 and the DSP 8 are the two independent processing units in the DPC 1. Although the tasks for the CPU and the DSP are clearly separated, both interact during start-up of the power system, as well as during normal operation.

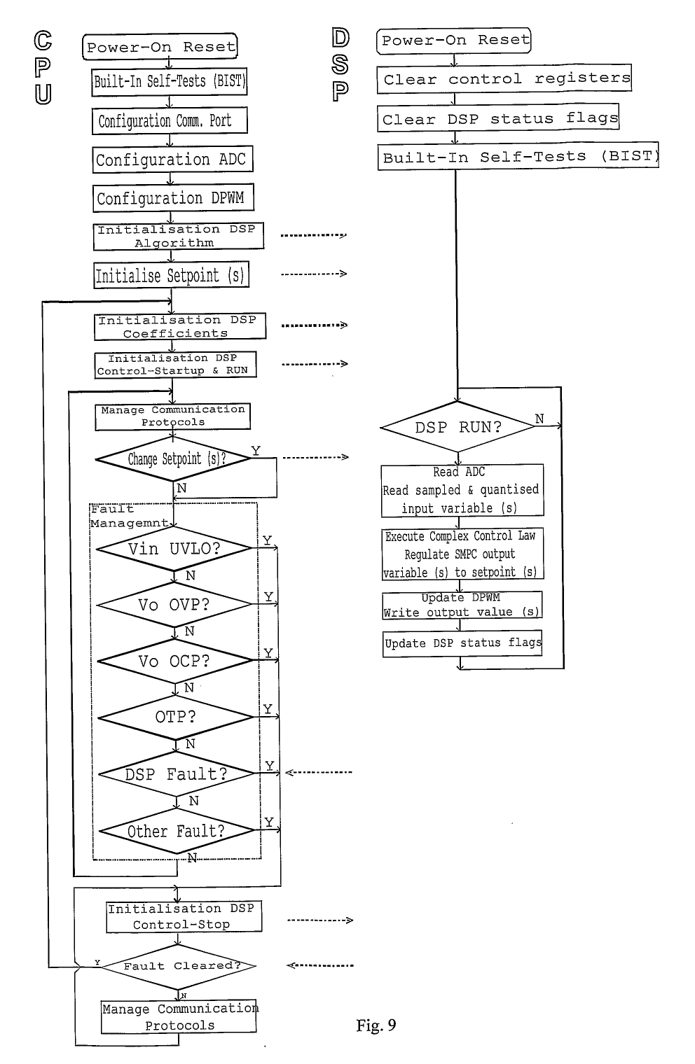

FIG. 9 illustrates the principal software tasks running on each of the processing units, during start-up as well as during normal operation. FIG. 9 also illustrates the typical interactions between the CPU 6 and the DSP 5. The interactions between CPU and DSP can be categorised as follows:
DSP algorithm transferred from non-volatile instruction memory through CPU into DSP local volatile instruction memory
DSP coefficients, determining the frequency behaviour of the control law, transferred from CPU into DSP after start-up. Depending on the particular control law, this initial set of coefficients may remain static, or may be modified by the DSP in case of more complex control laws (adaptive or self-tuning control laws)
Control system setpoints, setting target value(s) for SMPC variable(s) in closed-loop real-time control. During start-up, an initial setpoint is transferred from the CPU to the DSP. It should be noted that during normal operation the setpoint may change from time to time, e.g. if a host requests a change of setpoint. To do this, the host sends a request to the CPU through the communication port. The CPU transfers the new setpoint to the DSP, which in turn uses the new setpoint as the new target value in closed-loop control.
ON/OFF control of DSP by CPU. From time to time the CPU may request the DSP to seize (or resume) closed loop control. This may happen e.g. due to a request from the host through the communication channel that the power conversion should stop (during times when the load does not require electrical power) or start (when the load needs to be supplied with electrical power). This may also happen as a result of detection of fault detection, and recovery from fault detection.
DSP status flags transmitted from DSP to CPU, allowing detection of DSP faults, and adequate response to these faults.

In summary, the DPC 1 provides a flexible platform for the control of a wide range of power converters. This flexibility is based on the programmable CPU 6 and a programmable DSP (carrying out real-time mathematical operations, i.e. control law/control filter implementations with programmable coefficients).

Also, it provides a low-cost platform for control as the building blocks are predominantly digital and can thus be realised using standard CMOS processes. Either none or only a few external components are required, leading to low DPC pin-count and reduced PCB area. The architecture is readily scaled with improvements in CMOS process technology; and may be part of a larger complete system on a chip.

By providing a virtually unlimited number of connection points to the on-chip SoC bus 10, and full CPU 6 programmability, the architecture can be easily extended by additional peripheral blocks, and can thus satisfy future power converter requirements.

The programmable DSP 5 can support the implementation of advanced control laws. Implementations of advanced control laws using state-of-the-art continuous discrete circuitry are either very difficult (or costly), or impractical.

The DSP 5 is capable of implementing the control algorithms (allowing the power converter to operate under voltage or current mode control), and has a much reduced feature set in terms of hardware and software compared with off-the-shelf DSPs. As a programmable device it is capable of handling control schemes for a wide number of power converter applications, unlike hard-wired controllers. The control algorithms require ADC samples of the power converter output voltage and possibly the input voltage and output current. The result of the algorithm is a duty cycle command for the DPWM module. As a programmable device, the processor ADC 7 input ports and DPWM 8 output port support various ADC/DPWM resolution word lengths as these will vary depending on the application.

Experimentation with the required control algorithms revealed that only a few specific ADC samples of the power converter output voltage/current and corresponding filtering/scaling coefficients were required to be stored on-chip (in data memories). In addition, the length of the program to execute the algorithm is also quite short in terms of the on-chip program memory required. Hence both the on-chip data/program memory sizes have been optimised in size (resulting in silicon area saving) to meet the specific requirements of digitally controlled power converter algorithms.

The combination of separate program/data memories/buses, a datapath and a RISC-based instruction set form the DSP 5 allowing various control algorithms to be programmed depending on the application. A sub-set (30) of the many instructions (possibly >200) available in leading edge DSPs are supported by this DSP 5 to meet the requirements of the control algorithms which simplifies the programming of the device for the user. The programs (stored initially in the RISC processor program memory) are written to the local program memory in the DSP 5 at power-up, after which the DSP 5 works independently from the rest of the system.

The DSP 5 instructions allow the instruction type (e.g. ADD, LOAD) and data memory locations (containing the data to be manipulated) to be specified in a single instruction. The word length of each DSP instruction is 16 b (this can be either increased/decreased in future revisions). As the execution time for the entire control algorithm is vitally important in high switching power converters all of the DSP instructions support single clock cycle execution.

Digital control algorithms are typically executed once every switching cycle of the power converter switching frequency (e.g. once every 1 μs). The DSP 5 contains a sleep mode instruction allowing the processor to enter a low power mode after the algorithm is executed. The interrupt to allow the processor leave sleep mode and re-execute the control algorithm is optimised (from a timing perspective) to an operating point of the power converter which ensures the algorithm executes with average values of the power converter output voltage/current sampled by the ADC channels.

The central processor supports a single-word instruction which allows for highly efficient data transfers of data words from the processor to any peripheral block, using a minimum amount of clock cycles, and a minimum amount of instruction memory.

The word-length of an instruction (i.e. number of bits per instruction word) is limited, and can-be expressed as n_{IW}. A limited number of instructions can therefore be coded. As every instruction fetch from instruction memory takes time, and consumes instruction memory, it is preferable that all instructions (together with their operands) are coded using a single instruction word. This means that the word-length of the operands, expressed as n_{operand} needs to be smaller than n_{IW}, therefore n_{IW}>n_{operand}.

Operands may be: constants (sometimes also called literals); source/destination register addresses; and addresses or offsets in instruction memory or data memory.

Firmware for this application involves frequent movement of (constant) data from the RISC processor to the peripheral blocks of the DPC 1 (mainly the DSP 5, but also the ADC 7, and the DPWM 8).

Because of word-length limitations n_{IW}, instructions for RISC processors involve either none or a maximum of one variable (i.e. not fixed) operand. If an instruction would involve two variable operands, one would not be able to code all of the required information in one instruction word and the instruction would need to be broken down into two individual instructions, each involving one operand. Movement of constant data to a destination register residing in a peripheral block is an example for this. In the RISC processor 6, such a data movement involves two steps:
movement of the data into a RISC data register (such as the accumulator), and
movement of this data from the RISC data register to the destination register.

Also, each individual peripheral block only has a small set of registers (between 1-4 registers). If each peripheral block is assigned a base address, expressed as adr_{base}, the peripheral block register addresses can be expressed using offset addresses relative to the base address. A small number of bits, expressed as n_{offs}, most typically 0-2, is sufficient to code this offset address.

As long as n_{IW}>(n_{operand}+n_{offs}), a single instruction can be created, which effectively supports two operands (e.g. a constant operand, plus a register offset address), while at the same time keeping the required instruction word-length n_{IW} at a minimum.

The following applies:

n_{IW}=14b

n_{operand}=8b

n_{offs}=2b

adr_{base}=128

which supports an instruction opcode word-length of n_{IW}−n_{operand}−n_{offs}=4b.

The instruction mnemonic is

mov REG[r], #k

and the instruction is coded as

1110rrkkkkkkkk

where variable r expresses an offset in a range of 0 to 3, and k expresses a constant in a range of 0 to 255.

Coded as a single 14 b instruction word, taking a minimum amount of clock cycles to execute, and consuming a minimum amount of instruction memory, the instruction supports the movement constant data (k) to a hardware register residing in a peripheral block. The hardware register may be either a control register, or a data register, and is typically located in a peripheral block (such as the DSP).

The base address adr_{base} of the hardware register is fixed (and equal to 128), but may be made variable for enhanced flexibility. The effective address EA of the hardware register is therefore EA=adr_{base}+r, and in our specific case EA=128+r. Constant data k is written into hardware register with the address EA.

An extension of this concept is the movement of data from a hardware register into any other register, either CPU-internal, or located in any other peripheral block.

The invention may be effectively utilised to support embedded DSP code in firmware. DSP code will be translated by a programming language compiler (such as C or assembler) into corresponding data move instructions. This translation from DSP source code to data move instructions happens in a transparent fashion, allowing the programmer to code the algorithm using standard DSP source code. Effectively, every DSP instruction found in the language source code (e.g. the assembler code) will be broken into m data move instructions (with typically m=2 as n_{operand}=8 and DSP instruction word length n_{DSP}=16) of the previously discussed structure “mov REG[r],#k”. The destination of the data is the DSP, which receives the data, and writes it sequentially into its own local instruction memory, and thus prepares it for execution after the algorithm transfer is completed.

It will be appreciated that the invention extends significantly beyond the performance limits of the prior controllers, by including a fully programmable DSP co-processor. In contrast to the prior art, the invention supports the implementation of advanced control schemes (such as current mode control, predictive current mode control, dead beat control, non-linear control) by providing this fully programmable DSP co-processor.

The invention is not limited to the embodiments described but may be varied in construction and detail. For example, the co-processor may alternatively be of a different type, such as a numeric co-processor. Also, the power converter which is controlled may be of a type other than a switch mode power converter (SMPC), such as a linear regulator type of power converter.

1. A digital power controller for controlling a power converter, the controller comprising a CPU, a bus, and peripheral devices communicating with the CPU via the bus, said peripheral devices including a co-processor executing control algorithms, an ADC receiving power converter sense signals, and a modulator providing output drive signals to the power converter.

2. A digital power controller as claimed in claim 1, wherein the CPU has a RISC architecture.

3. A digital power controller as claimed in claim 1, wherein the digital power controller has a system-on-chip architecture.

4. A digital power controller as claimed in claim 1, wherein the peripheral devices operate as autonomous slaves.

5. A digital power controller as claimed in claim 1, wherein the modulator is a digital pulse width modulator (DPWM).

6. A digital power controller as claimed in claim 1, wherein the CPU performs housekeeping and communication operations, and the peripheral devices primarily perform real time power converter control.

7. A digital power controller as claimed in claim 1, wherein the CPU comprises blocks for self-test, peripheral device initialisation, parameter retrieval, and runtime routines.

8. A digital power controller as claimed in claim 1, wherein the CPU is configured to detect abnormal conditions and to generate real time responses.

9. A digital power controller as claimed in claim 8, wherein the CPU is configured to shut down the power converter in response to the detection of an abnormal condition.

10. A digital power controller as claimed in claim 9, wherein the CPU is configured to follow the shut-down with an automatic re-start attempt.

11. A digital power controller as claimed in claim 8, wherein said abnormal conditions include one or more of: over-temperature, input under-voltage lockout, output over-voltage, and output over-current.

12. A digital power controller as claimed in claim 1, wherein the CPU is configured to perform configuration of the peripheral devices.

13. A digital power controller as claims in claim 12, wherein the CPU is configured to perform initialisation of setpoint values for the co-processor executing control algorithms.

14. A digital power controller as claimed in claim 1, wherein the co-processor is a DSP.

15. A digital power controller as claimed in claim 1, wherein the CPU is configured to transfer a co-processor algorithm from non-volatile instruction memory to the co-processor.

16. A digital power controller as claimed in claim 1, wherein the CPU is configured at start-up to transfer to the co-processor control law and coefficients, the control law and coefficients determining the frequency behavior of the controller.

17. A digital power controller as claimed in claim 1, wherein the co-processor is configured to modify the control algorithms being run for adaptive control.

18. A digital power controller as claimed in claim 17, wherein the co-processor stores coefficients for adaptive control and is configured to modify the coefficients.

19. A digital power controller as claimed in claim 1, wherein the CPU and the co-processor are configured to co-operate to manage control system set-points, and set target values for power converter variables in closed-loop real-time control.

20. A digital power controller as claimed in claim 19, wherein the CPU is configured, during start-up, to transfer an initial set-point to the co-processor, and the co-processor is configured to change the set-point from time to time in response to CPU instructions, and to use the new set-point as a new target value in closed-loop control.

21. A digital power controller as claimed in claim 1, wherein the CPU is configured to request the DSP to resume closed loop control, in response to a request from a host that power conversion should stop or start or as a result of detection of fault detection, or recovery from fault detection.

22. A digital power controller as claimed in claim 1, wherein the co-processor is configured to transmit status flags to the CPU, allowing detection of DSP faults, and adequate response to these faults.

23. A power converter system comprising a power converter and a digital power controller as claimed in claim 1, wherein the power converter is a switch mode power converter.

24. (canceled)

25. A digital power controller as claimed in claim 1, wherein the co-processor executes a control algorithm at least once per switching cycle of the power converter.

26. A digital power controller as claimed in claim 25, wherein the co-processor is configured to enter a low power mode after execution of the control algorithms in a switching cycle.

27. A digital power controller as claimed in claim 26, wherein the co-processor is responsive to an interrupt to leave the low power mode.

28. A digital power controller as claimed in claim 27, wherein the controller is configured to generate the interrupt to cause the co-processor to leave the low power mode at an operating point in the cycle of the power converter which ensures average values for the converter sense signals received at the ADC.
